(19) United States
(12) Patent Application Publication
(10) Pub. No.: US 2013/0019524 A1
(43) Pub. Date: Jan. 24, 2013

(54) PLANT CONTAINER SYSTEMS AND STRUCTURES

(71) Applicant: Roger Collin, Portland, OR (US)

(72) Inventor: Roger Collin, Portland, OR (US)

(21) Appl. No.: 13/184,815

(22) Filed: Jul. 18, 2011

(51) Int. Cl. A01G 9/02; A01G 13/02; A01G 13/10

(52) U.S. Cl. 47/31; 47/83; 47/20.1; 47/66.6; 47/66.1

(57) ABSTRACT

Planting structures including a container including a base and defining a container opening opposite the base, a first bulb support structure supported within the container, the first bulb support structure defines a first bulb compartment located proximate the container opening, and a first bulb support structure height selected to position the first bulb compartment a first selected distance from the container opening, and a second bulb support structure supported within the container, the second bulb support structure defines a second bulb compartment located proximate the container opening, and a second bulb support structure height selected to position the second bulb compartment a second selected distance from the container opening. In some examples, the planting structure includes a varmint resistant enclosure extending from the base around an entire periphery of the base, the lateral enclosure terminating opposite the base defining a lateral enclosure opening opposite the base.

### BACKGROUND

The present disclosure relates generally to planting structures. In particular, planting structures that provide appropriate vertical and lateral spacing between one or more bulb containers are described.

Known methods for planting bulbs and planting structures are not entirely satisfactory for the range of applications in which they are employed. For example, existing methods for planting bulbs and planting structures require users, such as gardeners and landscapers, to manually dig individual holes for each bulb they desire to plant. Additionally, each bulb may have an associated suggested planting depth based on bulb type or size so each hole must be dug to a specific depth to accommodate each bulb. Achieving the suggested depth based on bulb type can be difficult to gauge and/or may be overlooked by users who are unaware of these requirements.

Additionally, not only may bulbs have suggested planting depths, but bulbs may also have suggested distances for laterally spacing bulbs from other bulbs depending on bulb size and type to allow for root growth and energy absorption throughout the growing season. Appropriate lateral spacing is also difficult to gauge and/or may be overlooked by users who are unaware of these requirements. Appropriate lateral spacing is important because if unaccounted for individual roots of one bull may become intertwined with the individual roots of another bulb. Additionally, if lateral spacing is unaccounted for one bulb upon sprouting and/or flowering may overshadow other bulbs and block other bulbs from absorbing precious energy needed to grow.

Additionally, even if a user plants bulbs at the appropriate depths with the appropriate lateral spacing, the bulbs are still left unprotected and may be eaten by varmints that feast on tasty bulbs and/or bulbs may rot overtime. Bulbs that either rot and/or are eaten by varmints require replanting, which can be a substantial burden on users who expect bulbs to last for multiple growing seasons.

Thus there exists a need for planting structures that improve upon and advance the design of known planting structures. Examples of new and useful planting structures relevant to the needs existing in the field are discussed below.

### SUMMARY

The present disclosure is directed to planting structures including a container including a base and defining a container opening opposite the base, a first bulb support structure supported within the container, the first bulb support structure defines a first bulb compartment located proximate the container opening, and a first bulb support structure height selected to position the first bulb compartment a first selected distance from the container opening, and a second bulb support structure supported within the container, the second bulb support structure defines a second bulb compartment located proximate the container opening, and a second bulb support structure height selected to position the second bulb compartment a second selected distance from the container opening. In some examples, the planting structure includes a varmint resistant enclosure extending from the base around an entire periphery of the base, the lateral enclosure terminating opposite the base defining a lateral enclosure opening opposite the base.

### BRIEF DESCRIPTION OF THE DRAWINGS

FIG. 1 is an isometric view of a first example of a planting structure.

FIG. 2 is a section view of the planting structure of FIG. 1 showing a first bulb support structure and a second bulb support structure.

FIG. 3 is a section view of the planting structure of FIG. 1 with a support structure stack removed to reveal an interlocking feature.

FIG. 4 is a top view of the planting structure of FIG. 1 showing different lateral spacing between bulbs and bulb support structures based on bulb variety.

FIG. 5 is a section view a planting structure showing multiple bulbs of the same bulb variety supported at preselected heights to delay growth thereby extending the growing season.

FIG. 6 is an isometric view showing a first planting structure with a first preselected floral arrangement and a second planting structure with a second preselected floral arrangement.

FIG. 7 is a front, top, and bottom elevation view showing an individual support structure with an interlocking feature for interlocking with other individual support structures.

FIG. 8 is an isometric view showing how several individual support structures may be stacked and/or interlocked with each other individual support structures.

### DETAILED DESCRIPTION

The disclosed planting structures will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various planting structures are provided. Related features in the examples may be identical, similar, or dissimilar in different examples. For the sake of brevity, related features will not be redundantly explained in each example. Instead, the use of related feature names will cue the reader that the feature a related feature name may be similar to the related feature in an example explained previously. Features specific to a given example will be described in that particular example. The reader should understand that a given feature need not be the same or similar to the specific portrayal of a related feature in any given figure or example.

As described herein, bulb may be used interchangeably with what is known in the art as a geophyte. A geophyte is known in the art as a perennial plant, such as a crocus, tulip, propagated, potato, or daffodil, which in spring propagates from an underground storage organ such as a bulb, tuber, corm, or rhizome.

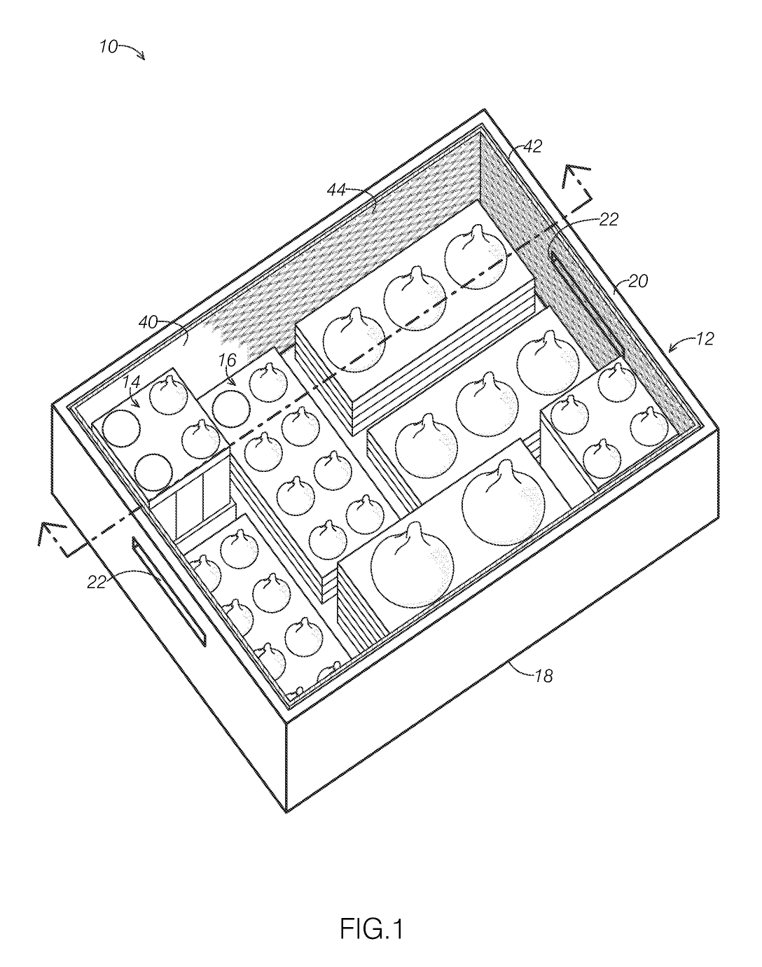

With reference to FIGS. 1-8, a first example of a planting structure will now be described. Planting structure 10 includes a container 12, a first bulb support structure 14, and a second bulb support structure 16. Planting structure 10 functions to provide a solution for planting a variety of bulbs by providing a container with bulb support structures that arrange the variety of bulbs at the proper vertical spacing and lateral spacing for optimal growth when planted, ultimately taking the guesswork out of bulb planting. Additionally or alternatively, planting structure 10 may be used to protect planted bulbs from varmints that may otherwise eat the planted bulbs if left unprotected.

Additionally or alternatively, planting structure 10 may be used to control the growing sequence of multiple planted bulbs such that the sprouting of each bulb type is sequentially delayed by an approximate time period. In some examples, this period of delay may extend the growing season of the planted bulbs. While in other examples, this period of delay may cause the planted bulbs to sprout at substantially the same time.

Additionally or alternatively, planting structure 10 may function to provide a first preselected floral arrangement. Additionally or alternatively, planting structure 10 may be used in combination with a second planting structure such that planting structure 10 may function to provide a first preselected floral arrangement add the second planting structure may function to provide a second preselected floral arrangement.

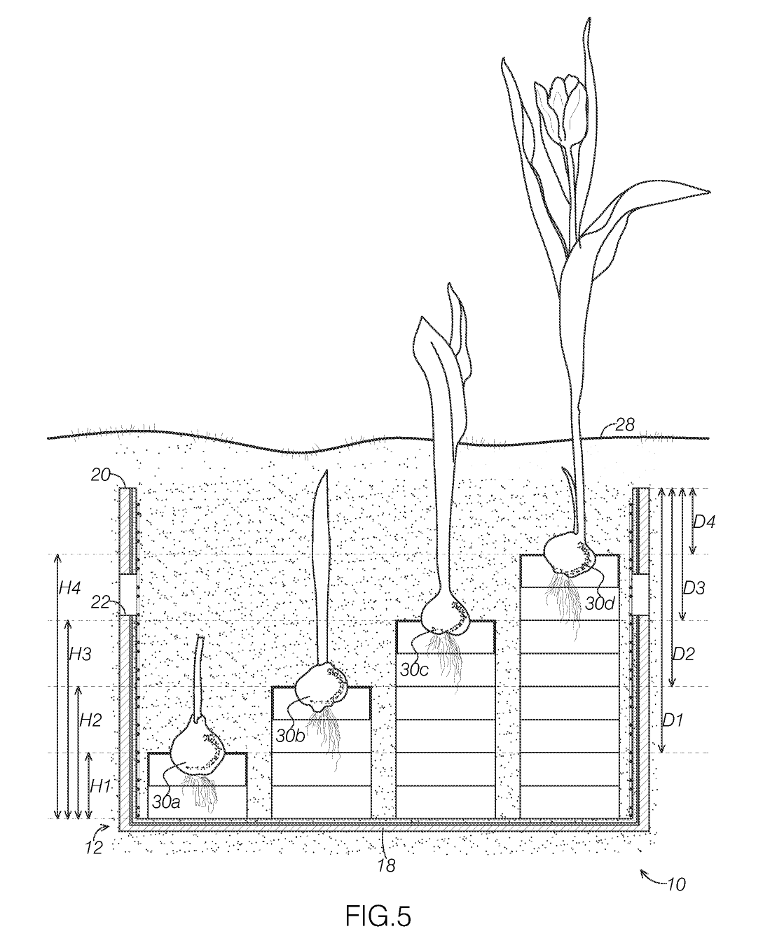

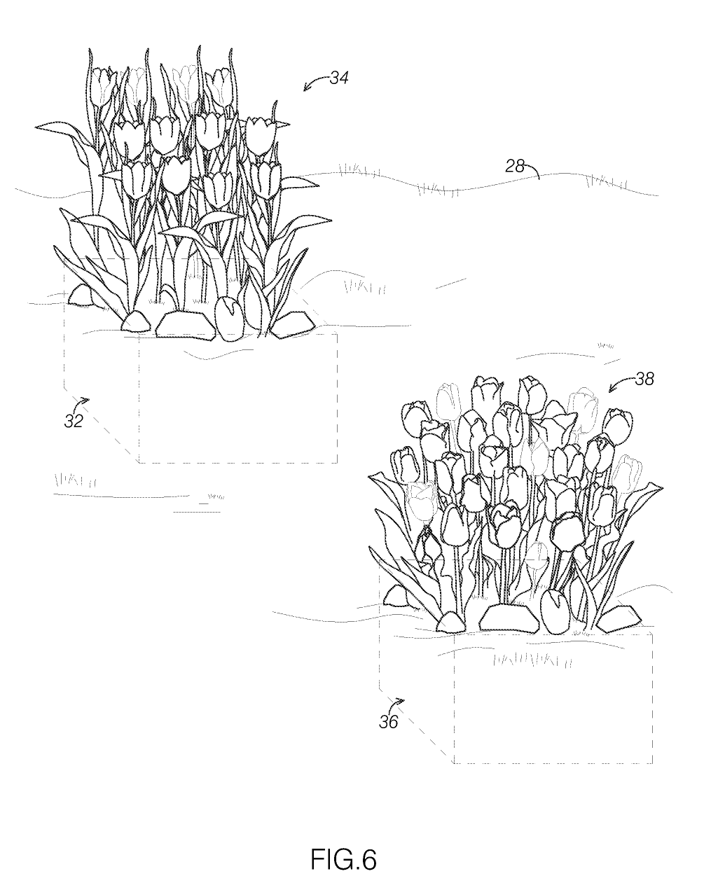

As shown in FIGS. 5 and 6, planting structure 10 may be planted in the ground where a user may dig a hole approximately the size of planting structure 10 and place planting structure 10 within the hole. Additionally or alternatively, the planting structure may be located above ground. For example, a user may insert the planting structure within a planter box as known in the art and/or a user may surround the planting structure with soil, brickwork, and/or stonework. Additionally or alternatively, the planting structure may come in a variety of shapes and sizes and be a hanging planting structure.

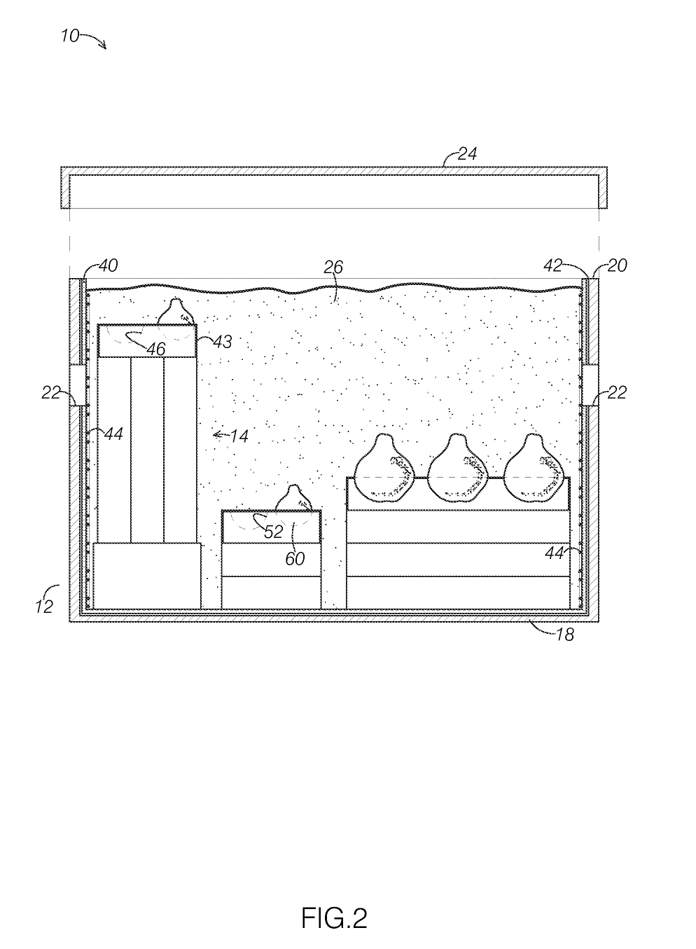

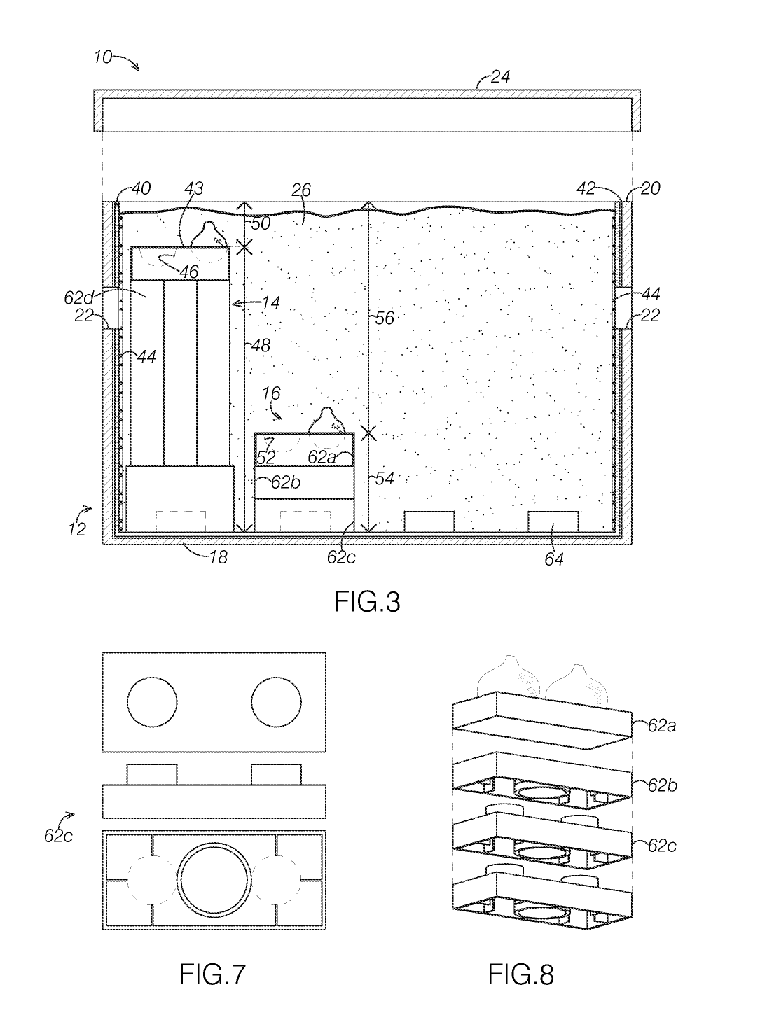

As can be seen in FIGS. 1-3, container 12 includes a base 18 and defines a container opening 20 opposite the base. Container 12 further includes optional handles 22 that may be located on the container walls and a container cover 24 (as shown in FIGS. 2-3) for covering container opening 20.

Container 12 may be made from any suitable material that may be non-biodegradable, biodegradable, and/or compostable material such as plastic, wood, metal, cardboard, and/or a PLA (Polylactic acid) plastic a compostable plastic derived from corn. Container 12 may be made from a single material or some combination of multiple materials. Additionally or alternatively, the container may be configured to decompose in a natural composting process to enrich the soil. In the preferred embodiment, container 12 is made from biodegradable (and compostable?) cardboard.

Container 12 may provide the necessary structure to move, planting structure 10 may from place to place without requiring additional support structure. For example, planting structure 10 may be transported from a store to a home where planting structure 10 may be used to grow a variety of bulbs.

As shown in FIGS. 1-3, base 18 supports multiple bulb support structures. As shown, first bulb support structure 14 and second bulb support structure 16 are supported within container 12 by base 18. In some embodiments, container 12 may be of uniform thickness throughout including the container walls and the base. While in other embodiments, the container may have variable thickness along the base and walls.

For example, it may be desirable, to increase the base thickness of the container since the base supports the bulk of the load during use, while the containing walls support little load. That said, there may be instances where the container walls will support some vertical load such as during transport or storage of the planting structure where multiple planting structures may be stacked one on top of the other. Additionally, there may be circumstances where unforeseen items may be stacked on top of the planting structures. In the case of transport and in the case of supporting a load, a container cover may be helpful in distributing the load and providing more structure to the container walls.

As shown in FIGS. 1-5, container opening 20 may be integral to container 12, and is located opposite base 18. Container opening 20 may serve a variety of functions including providing access within container 12 where one or more bulb support structures may be accessed and/or placed. Additionally, container opening 20 provides an opening for one or more bulbs to sprout from, without such an opening the bulbs would have to penetrate through the container to grow. Additionally or alternatively, container opening 20 may provide access for adding a growth medium 26 such as soil and/or fertilizer.

As shown most clearly in FIG. 5, container opening 20 may be located proximal to ground surface 28 and one or more bulbs 30 may be contained within container 12 below ground surface 28. Additionally or alternatively, container 12 may be placed on a surface, such as the ground, and then one may build up medium around the container using container opening 20 as a guideline to determine how high to build up the surrounding medium, such as soil or some other above ground enclosure such as brickwork or stonework. In any respect, container opening 20 may serve as a guide or baseline for locating one or more bulb support structures at a specified depth for optimal growth and/or for controlling growth sequence by depth, which is discussed in further detail below.

Turning to FIG. 1, container 12 includes optional handles 22. Handles 22 may be any suitable handle known in the art. As shown, handles 22 are slots within the container that allow user's hand to pass through. Additionally or alternatively, the handles may be a common metal handle that swings freely similar to handles found on certain sliding drawers. Additionally or alternatively, the handles may be integrated into the container near the container opening and serve as an additional way of locating the container. This may be particularly useful, if, for example, a user wanted to remove or transport the planting structure. A user wanting to transport an already planted planting structure may uncover the handles and use the handles to transport the container to a separate location.

Turning to FIG. 6, a first planting structure 32, designed to produce a first preselected floral arrangement 34 and a second planting structure 36 designed to produce a second preselected floral arrangement 38 are shown planted underground with the container opening located proximal a ground surface. Suppose, for example, a user inadvertently placed first planting structure 32 in a hole or other location intended for second planting structure 36, such a mistake would be more difficult to remedy without handles located near the container opening. Additionally, it is foreseeable that a user may grow tired of the same floral arrangement year after year and the handles may serve as a means for uprooting the first planting structure and replacing it with another planting structure.

As shown in FIGS. 1-3, container 12 further includes a varmint resistant enclosure 40. Varmint resistant enclosure 40 may extend from base 18 around an entire periphery of base 18, and varmint resistant enclosure 40 may terminate opposite the base to define a lateral enclosure opening 42 opposite the base and substantially equal to the container opening. When the varmint resistant enclosure extends around an entire periphery of the base it protects the container from a lateral attack by varmints. Additionally or alternatively, varmint resistant enclosure 40 may further extend across base 18 protecting planting structure 10 from an underneath attack.

As noted above, the varmint resistant enclosure serves to protect bulbs from varmints that would otherwise eat the bulbs. If properly protected, some bulbs will last for one or more seasons, which saves users from locating, unearthing, and replanting bulbs.

Varmint resistant enclosure 40 may be made from a variety of materials including wood, metal such as steel, and/or wire mesh. In the embodiment shown in FIGS. 1-5, a wire mesh 44 is employed to serve as a varmint resistant enclosure. Additionally or alternatively, varmint resistant pellets may be used instead and/or in addition to the varmint resistant enclosure. Additionally or alternatively, in some embodiments a varmint repellant applied to the container and/or incorporated within the container such as infusing and spraying the container with varmint repellant.

As shown in FIGS. 1-5, one or more bulb support structures may be contained within container 12. With reference to FIG. 3, a first bulb support structure 14 is shown supported within container 12 by base 18. First bulb support structure 14 includes a first bulb container 43, a first bulb compartment or receptacle 46 defined by first bulb container 43 proximate container opening 20. Additionally, a first support structure height 48 may be selected to position first bulb receptacle 46 a first selected distance 50 from container opening 20.

Additionally, planting structure 10 includes a second bulb support structure 16 supported within container 12 by base 18. Second bulb support structure 16 includes a second bulb container 51, a second bulb receptacle 52 defined by second bulb container 51 proximate container opening 20. Additionally, a second support structure height 54 may be selected to position second bulb receptacle 52 a second selected distance 56 from container opening 20.

As shown in FIG. 3, first bulb receptacle 46, and may support a first bulb 58, and second bulb receptacle 52 may support a second bulb 60. Additionally or alternatively, first selected distance 50 and second selected distance 56 may be selected to grow a first bulb variety in first bulb support structure 14 and a second bulb variety in second bulb support structure 16.

As shown in FIGS. 1-3, different bulb varieties and sizes may be positioned at various distances from container opening 20. The bulb support structures may accommodate this by providing a plurality of bulb support structure heights that result in positioning supported bulbs at selected distances from the container opening. For example, first bulb variety may have a suggested planting depth of D1 for optimal growth, the first planting depth may be provided by appropriately sizing first support structure height 48 such that first bulb compartment 14 may be positioned a first selected distance 50 from container opening 20, the first selected distance being substantially equivalent to the first planting depth D1. Likewise, another bulb variety may have a suggested planting depth of D2, which could be accommodated in a similar way by appropriately sizing the height of a second bulb support structure to be approximately equal to planting depth D2 from the container opening. Following these guidelines may result in a planting structure having bulbs with substantially similar growing cycles.

As shown most clearly in FIG. 5, the same bulb variety may be positioned at various selected distances from the container opening. Positioning one or more bulbs a greater distance from an energy source, such as the sun or a plurality of Light emitting Diodes (LEDs) in the case of indoor growth, may extend the above ground growing season. Indeed, with selective bulb depth positions as one bulb nears the end of its above ground growing season another bulb just begins its above ground growing season or the bulb may be partially through its growing season. For example, a first support structure height H1 may be selected to position a first bulb 30c, supported by a first bulb receptacle 46, a first selected distance D1 from container opening 20. Likewise, a second support structure height H2 may be selected to position a second bulb 30d supported by a second bulb receptacle 52 a second selected distance D2 from container opening 20. As shown in FIG. 5, first bulb 30d has fully sprouted and flowered, while second bulb 30c has only just sprouted and has yet to flower.

As shown FIGS. 1-3, 5, 7, and 8, the bulb support structures may be comprised of several individual support structures that may stack in a variety of unique orientations. As shown most clearly in FIGS. 1-3, 7, and 8, a planting structure may include a plurality of support structures configured to be positioned at different lateral positions on the bottom end or base of the container and to be selectively stacked to define one or more support structure stacks of one or more support structures. Moreover, each support structure stack may define a stack height depending on how many support structures are included in the support structure stack. Furthermore, there may be a plurality of bulb containers supported by the one or more support structure stacks.

With reference to FIGS. 7 and 8, several individual support structures are shown stacked in a variety of unique ways. As shown, individual support structures 62a, 62b, and 62c are shown stacked horizontally, while individual support structures 62d are shown stacked vertically. Additionally or alternatively, individual support structures such as 62b or 62c may interlock with other individual support structures such as 62h or 62c and/or interlock with a planting structure interlocking feature 64. In some embodiments, the bulb containers may include interlocking features such that the first bulb container and the second bulb container may be configured to mount interchangeably on the one or more individual support structure stacks.

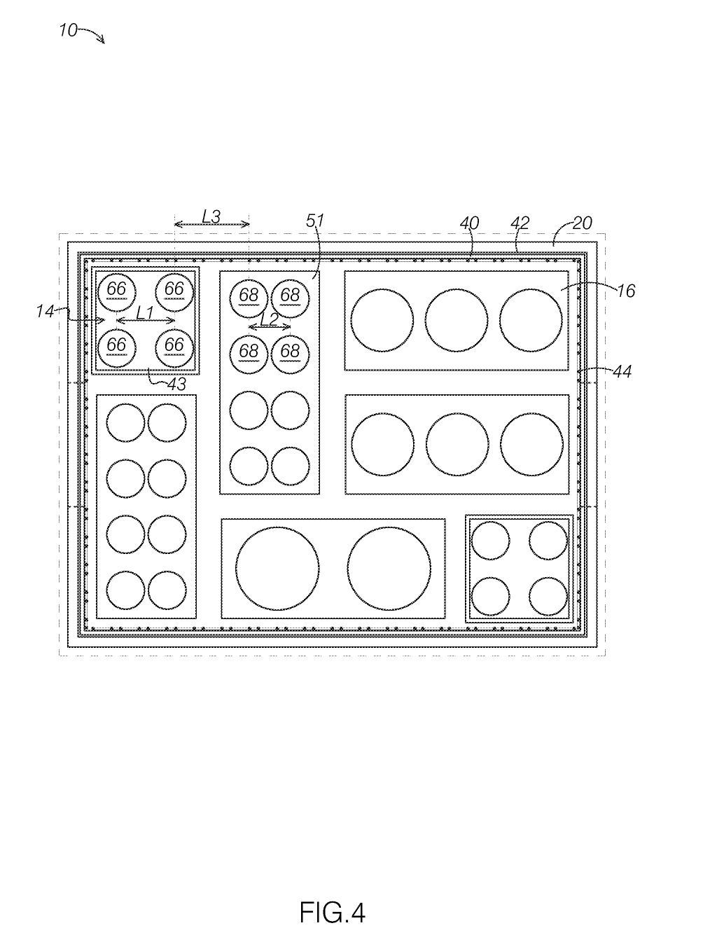

As shown in FIG. 4, first bulb container 43 may define a first lateral spacing L1 between a plurality of first bulb compartments 66, first lateral spacing L1 may be preselected based on bulb size or type. Additionally, second bulb container 51 that may define a second lateral spacing L2 between a plurality of second bulb compartments 68. Second lateral L2 spacing may be preselected based on bulb size or type. Additionally or alternatively, first bulb container 43 and second bulb container 51 may define a third lateral spacing L3 between first bulb compartment 66 and second bulb compartment 68 once mounted to the one or more support structure stacks. Third lateral spacing L3 may be preselected based the bulbs to be received in the first and second bulb containers. Appropriate lateral spacing may desired to ensure that bulbs have sufficient room for root growth and for energy absorption throughout the growing season.

As demonstrated throughout FIGS. 1-5, a plurality of bulbs may be supported and arranged in a variety of unique arrangements, which in turn may lead to a variety of unique preselected floral arrangements. For example, as shown in FIG. 6 and discussed previously, a first preselected floral arrangement 34 is shown proximal a second preselected floral arrangement 38. The first preselected floral arrangement may sprout from first planting structure 32, which may be referred to as a first plant container system. Additionally, first planting structure 32 may contain a plurality of bulbs supported within a first bulb container that may define a first set of bulbs distinct from a second set of bulbs that may be supported within a second bulb container. Moreover, the arrangement of the first bulb container and the second bulb container may define first preselected floral arrangement 34. Furthermore, the second preselected floral arrangement may sprout from second planting structure 36, which may be referred to as a second plant container system. Second planting structure 36 may for all intents and purposes be substantially similar to first planting structure 32, except the arrangement, selection, and/or coordination of the plurality of bulbs contained within second planting structure 6 may define a second preselected floral arrangement 38 that may be distinct from first preselected floral arrangement 34. The first plant container system and the second plant container system may be planted or located proximal each other to provide a variety of floral arrangements. Users such as homeowners may desire having one or more choices of preselected floral arrangements for displaying at their home. Additionally, landscapers may also iii it desirable to have one or more preselected floral arrangements to choose from.

In some embodiments, bulbs may come pre-pact in bulb compartments and/or bulb containers. However, in other embodiments bulb compartments and/or bulb containers may be color-coded to identify one or more bulb types that the bulb compartments and/or bulb containers are suitable for receiving. Additionally, a user may selectively place the bulbs in each bulb compartment. Additionally, there may be a manual included with the planting structure that specifies lateral spacing based on bulb type and the manual may provide insight into which bulbs should be located proximal or distal from each other to provide optimal growth.

Additionally or alternatively, the manual may provide appropriate planting depths based on bulb variety and size, and/or the manual may offer insight on how to plant the same bulb type at various depths to achieve an extended growing season as described above and shown in FIG. 5. Additionally, the manual may provide insight on how to stack the various support structures to achieve appropriate heights for optimal growth, depending on bulb variety, bulb size, and/or if an individual user desires to delay or extend the above ground growing season by locating bulbs at various depths. Additionally or alternatively, a manufacture may use the individual support structures to fulfill custom orders for various bulb varieties from a user.

As described above, various bulb support structure heights may be appropriate depending on bulb variety and size and/or if an extended growing season is desired. To this end, the planting structure may include preformed bulb support structures of various heights. For example, the first bulb support structure and the second bulla support structure may be one or more molded units that may be located within the container. In some embodiments, a single mold may be used to form a single unit that includes a plurality of bulb containers and support structures such that the single unit may be placed within a container. The bulb support structures may be molded from plastic, cardboard, and/or PLA plastic. Additionally or alternatively, the bulb support structures may come infused or coated with a mold or rot repellant to prevent bulb rot, this is regardless of whether the bulb support structures are molded as a single unit or as individual units.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader narrower or equal in scope to the original claims, are to be considered within the subject matter of the inventions described herein.

1. A planting structure comprising:
a container including a base and defining a container opening opposite the base;
a first bulb support structure supported within the container, the first bulb support structure defining:
a first bulb compartment located proximate the container opening, and
a first bulb support structure height selected to position the first bulb compartment a first selected distance from the container opening; and
a second bulb support structure supported within the container, the second bulb support structure defining:
a second bulb compartment located proximate the container opening; and
a second bulb support structure height selected to position the second bulb compartment a second selected distance from the container opening.

2. The planting structure of claim 1, further comprising a varmint resistant enclosure extending from the base around an entire periphery of the base, the lateral enclosure terminating opposite the base to define a lateral enclosure opening opposite the base substantially equal to the container opening.

3. The planting structure of claim 2, wherein the varmint resistant enclosure farther extends across the base.

4. The planting structure of claim 2, wherein the varmint resistant lateral enclosure is wire mesh.

5. The planting structure of claim 1, further comprising a varmint repellant applied to or incorporated within the container.

6. The planting structure of claim 1, wherein the first selected distance and the second selected distance are selected to allow for growing a first bulb in the first bulb support structure and a second bulb in the second bulb support structure.

7. The planting structure of claim 1, wherein the first selected distance from the container opening is smaller than the second selected distance from the container opening to delay the growth of a bulb supported in the second bulb support structure relative to the growth of a bulb supported in the first bulb support structure.

8. The planting structure of claim 1, further comprising a growth medium.

9. The planting structure of claim 1, wherein the container is configured to decompose in a natural composting process to enrich the soil.

10. A plant container system comprising:
a container having a bottom end;
a plurality of support structures configured to be positioned at different lateral positions on the bottom end and to be selectively stacked to define one or more support structure stacks of one or more support structures, each support structure stack defining a stack height depending on how many support structures are included in the support structure stack; and
one or more bulb containers supported interchangeably on the one or more support structure stacks.

11. The plant container system of claim 10, wherein the one or more bullas containers includes a first bulb container and a second bulb container the first bulb container mounts to one or more support structure stacks defining a first support structure height, and the second bulb container mounts to one or more support structure stacks defining a second support structure height.

12. The plant container system of claim 10, wherein the one or more bulb containers includes a first bulb container defining a first bulb compartment configured to receive a first size bulb, and a second bulb compartment configured to receive a second size bulb.

13. The plant container system of claim 12, wherein the first bulb compartment is spaced a first preselected lateral distance from the second bulb compartment to accommodate the growth characteristics of the first size bulb to be received in the first bulb compartment.

14. The plant container system of claim 13, further comprising a first preselected bulb supported within the first bulb compartment of the first bulb container and a second preselected bulb supported within the second compartment of the second bulb container.

15. The plant container system of claim 14, wherein the arrangement of the first bulb container and the second bulb container define a first preselected floral arrangement.

16. The plant container system of claim 15, wherein the plant container system defines a first plant container system and further comprising a second plant container system comprising:
a container having a bottom end;
a plurality of support structures configured to be positioned at different lateral positions on the bottom end and to be selectively stacked to define one or more support structure stacks of one or more support structures, each support structure stack defining a stack height depending on how many support structures are included in the support structure stack;
one or more bulb containers supported interchangeably on the one or more support structure stacks;
the one or more bulb containers includes a first bulb container defining a first bulb compartment configured to receive a first size bulb, and a second bulb compartment configured to receive a second size bulb;
a first preselected bulb supported within the first bulb compartment of the first bulb container and a second preselected bulb supported within the second compartment of the second bulb container, wherein the arrangement of the first bulb container and the second bulb container define a second preselected floral arrangement;
and the second plant container system is spaced a preselected lateral distance from the first plant container system.

17. The plant container system of claim 14, wherein:
the first preselected bulb contained within the first bulb compartment and the second preselected bulb supported within the second bulb compartment are substantially equivalent; and
the first support structure height and the second support structure height are configured to delay growth of the second preselected bulb contained within the second bulb compartment by a preselected period.

18. A planting structure comprising:
a container including:
a base, and
a varmint resistant lateral enclosure extending from the base around an entire periphery of the base, the lateral enclosure terminating opposite the base to define an enclosure opening opposite the base; and
a first support structure supported within the lateral enclosure from the base and including a first bulb compartment to receive a first selected category of bulbs, wherein the first support structure defines a first height that positions the first bulb compartment at a depth relative to a container opening opposite the base that corresponds to a suitable planting depth for the first selected category of bulbs.

19. The planting structure of claim 18, further comprising a second support structure supported within the lateral enclosure from the base and including a second bulb compartment to receive a second selected category of bulbs wherein the second support structure defines a second height that positions the second bulb compartment at a second depth relative to the container opening that corresponds to a suitable planting depth for the second selected category of bulbs.

20. The planting structure of claim 19, further comprising:
a first preselected bulb supported within the first bulb compartment; and
a second preselected bulb supported within the second bulb compartment;
wherein the first preselected bulb and the second preselected bulb have substantially the same growing cycle.
